(19) United States
(12) Patent Application Publication
(10) Pub. No.: US 2008/0138787 A1
(43) Pub. Date: Jun. 12, 2008

(54) System and method for diagnosing deficiencies and assessing knowledge in test responses

(76) Inventor: Pini A. Weinstein, Metairie, LA (US)

Correspondence Address: JOHN S. CHRISTOPHER, ESQ., 1237 22ND STREET, UNIT #4, SANTA MONICA, CA, 90404-1325, US

(21) Appl. No.: 12/006,169

(22) Filed: Dec. 29, 2007

Related U.S. Application Data
(63) Continuation-in-part of application No. 10/893,067, filed on Jul. 17, 2004, now abandoned.

(51) Int. Cl. G09B 7/00

(52) U.S. Cl. 434/362

(57) ABSTRACT

A system and method for diagnosing deficiencies and assessing knowledge in test responses comprises a computerized testing station for presenting questions to a responder. An initial response analyzer communicates with the testing station for determining the correctness of each literal response by the responder to each question. A necessary knowledge determiner is disposed to analyze each literal incorrect response to each question from the initial response analyzer for detecting responder's specific deficiencies in past cumulative knowledge and in new subject matter knowledge. A cumulative knowledge analyzer and a production rule analyzer are each provided for analyzing each of responder's literal incorrect responses to each question for identifying each specific deficiency in past cumulative knowledge and in new subject matter knowledge, respectively. Finally, a report generator communicates with the cumulative knowledge analyzer and the production rule analyzer for generating a written deficiency report of responder's specific deficiencies.

This application is a Continuation-in-Part of patent application having Ser. No. 10/893,067 entitled System and Method For Diagnosing Deficiencies and Assessing Knowledge In Test Responses filed on Jul. 17, 2004 and claims priority therefrom, this Continuation-in-Part Application being filed under 37 C.F.R. 1.53(b)(2).

### BACKGROUND OF THE INVENTION

1. Technical Field

The present invention relates to educational testing systems. More specifically, the present invention relates to methods and apparatus for identifying the specific deficiencies in required past cumulative knowledge or in new subject matter which are responsible for a student's inability to understand the test subject matter, and in assessing the student's knowledge.

2. Background Art

Educational testing methods are commonly employed in modern teaching and instructional programs. It is known that one of the most important aspects of teaching is the need to ascertain the prior knowledge of a student in a particular subject before introducing new information to the student in that subject. Most knowledge is cumulative and thus builds upon prior knowledge. Therefore, the lack of prior knowledge in the subject will inhibit the acquisition of newly presented knowledge associated with that subject. Therefore, (1) a primary diagnosis of what prior knowledge and skills has the student not mastered and the reason why, and (2) a continuing assessment of why the student is not currently mastering this knowledge in the relevant subject matter, are considered by educators to be of substantive importance.

It is very time consuming for teachers to manually administer an initial diagnostic test. Further, daily and/or weekly assessments of newly taught knowledge are also time prohibitive. The standard initial diagnostic tests currently employed in the teaching profession require several hours to administer and fail to offer a comprehensive assessment of definitive knowledge in the subject matter. Even if the diagnostic tests are administered, the most important aspects of the student's knowledge are not addressed. For example, the relevance of the diagnostic test results that determine that the student possesses the knowledge that places her at a particular grade level is questionable simply because this is not the most important information. Unfortunately, this is the result derived from current diagnostic tests. Further, the determination derived from the diagnostic test that a student is not knowledgeable in sentence structure, for example, nouns, is also not the most important information. Rather, the most important information is what is the student's knowledge of nouns, i.e., does the student really understand what a noun is. Does the student possess a critical understanding of the definition and how a noun functions in a sentence and the rules that distinguish a possessive noun versus a plural noun. However, it is very important to determine which production rules the student does not understand about nouns.

Current diagnostic testing administered by many state education departments typically only identifies that the student understands nouns, pronouns, verbs, adverbs, adjectives, etc. However, the current diagnostic testing does not stipulate what the student knows about each of these parts of speech. Therefore, the results of the diagnostic tests currently employed are not beneficial to the teacher because the information derived from these tests is too general. It is noted that most diagnostic testing requires only that the student provide the correct answer to the question. If the proffered answer is correct, then it is assumed based upon the testing logic that the student understands the tested subject matter. If the answer is incorrect, then it is assumed based upon the testing logic that the student does not understand the tested subject matter. Unfortunately, the diagnostic test result fails to define what definitive aspect of the knowledge the student does not understand.

During instruction by a teacher, some students fail to grasp the essence of the subject matter. Thus, the most important information to be gleaned from those students is why do they not understand the subject matter, i.e., what is the error that those students are making? Once the error is identified, the teacher can then focus on that particular aspect of knowledge. Further, it should be emphasized that students can become bored, frustrated and aggravated when they are being re-taught portions of the subject matter that they already understand but that the portions of the subject matter that they do not understand is not being reviewed.

Several educational methods and apparatus have been known in the past that are employed to assess a student's progress in the subject matter to which they are exposed. One of these is disclosed in U.S. Pat. No. 5,934,909 to Ho entitled Methods And Apparatus To Assess And Enhance A Student's Understanding In A Subject. Ho et al. disclose an educational method and system that allegedly automatically assess and enhance a student's understanding in a subject, and based on a student's understanding, individually-tailored tests are generated, whose difficulties are geared towards the student's level of understanding in the subject. It is further alleged that the student can not only use the tests to prepare for an examination, but can also use the tests to learn the subject. In one preferred embodiment, Ho et al. state that the assessment and enhancement take into account the student's past performance. In another preferred embodiment, Ho et al. allege that the invented method and system are based upon the latest test results from the latest test taken by the student on the subject, which is divided in line-items. In yet another preferred embodiment, Ho et al. alleges that at least one line-item is more difficult than another line-item where the latest test includes questions with different line-items.

Ho et al. allegedly disclose a score generator coupled to a recommendation generator which in one embodiment includes an inference engine, and in another embodiment includes a pre-requisite analyzer. Ho et al. discloses that the recommendation generator is coupled to a report generator and a question generator. The score generator preferably accesses the student's prior-to-the-latest test results in the student's test results table, and the latest test results as to generate one overall score for each set of questions that belongs to the same line-item. In one embodiment, the prior-to-the-latest test results is defined as the test results from the test immediately before the latest test. Both the pre-requisite analyzer and the inference engine in the recommendation generator are represented by Ho et al. as being able to generate recommendations based on the student's test results table. The pre-requisite analyzer accesses pre-requisite rules which according to Ho et al. are based on the complexity levels of the line-items, and determines a complexity-hierarchy among the line-items. Then, applying the complexity-hierarchy to the test results table, Ho et al. note that the pre-requisite analyzer determines the student's level of understanding in the subject to provide recommendations for the student. Next, Ho et al. note that the inference engine accesses a set of relationship rules that define the relationship among the line items and the subject. Then applying the set of relationship rules to the student's test results table, Ho et al. state that the inference engine determines the student's level of understanding in the subject to provide recommendations to the student.

As is clear from the foregoing and from a thorough review of the '909 patent reference including the claims, the method disclosed by Ho et al. relies on the student's past test scores, i.e., test scores from the latest test results and the prior-to-the-latest test results, to generate the next list of questions to be presented to the student. Ho does not appear to be analyzing the answers to the questions presented in the test that the student is currently engaged in. Further, Ho et al. emphasizes that the difficulty of the individually-tailored tests generated for the student is geared towards the student's level of understanding in the subject. Ho does not appear to be analyzing each step in the solution to the problem for enabling the identification of specific deficiencies in the student's understanding of the solution to the problem.

U.S. Pat. No. 6,491,525 to Hersh allegedly discloses an application of multi-media technology to psychological and educational assessment tools. This patent allegedly discloses a method of evaluative probing that avoids the inherent bias occurring through differences in language or dialect.

U.S. Pat. No. 6,540,520 to Johnson allegedly discloses an intelligent tutoring methodology using consistency rules to improve meaningful response. This invention allegedly provides a tutoring system that uses fundamental rule sets and artificial intelligence to identify problem-solving principles overlooked or not understood by the student.

U.S. Pat. No. 6,551,109 to Rudmik allegedly discloses a computerized method of and system for learning. This invention allegedly discloses a computerized learning system that periodically reviews a student's knowledge and identifies areas requiring further review.

U.S. Pat. No. 6,585,517 to Wasowicz allegedly discloses a phonological awareness, phonological processing, and reading skill training system and method. This patent allegedly discloses a method for training a user to discriminate sounds and evaluating the user's auditory processing, phonological awareness, phonological processing, and reading skills.

U.S. Patent Publication No. US 2004/0018479 to Pritchard et al. allegedly discloses a computer implemented tutoring system, which is applicable to a variety of specific knowledge domains, conducts an interactive dialog with a student. The dialog helps the student arrive at a correct solution to a problem, for example, by presenting problems in multiple parts, providing hints or simpler sub-parts to the student when requested or appropriate, and responding usefully to the student's wrong answers. The system interprets the nature of a student's errors to adapt the interaction to that student. For example, the system can select questions based upon a detailed assessment of the student's knowledge. The questions can have a variety of types of answers, including freeform answer types, for example symbolic expressions. The system can include authoring tools to let teachers write problems, displays detailed information on how students interact with these problems, and allows teachers to address frequently given incorrect responses. The system can provide a skill rating of each student on a preselected list of topics, each of which might be an element of knowledge for example declarative, conceptual, or procedural knowledge.

U.S. Patent Publication No. US 2004/0191746 to Maron et al. allegedly discloses a method of computerized grading of multi-step problems, of the type that formerly would be graded by hand.

Thus, there is a need in the art for a system and method for diagnosing deficiencies and assessing knowledge in test responses by a student responder at the time the student responder is responding to test questions which includes a computerized testing station for presenting test questions and receiving student responses, an initial response analyzer for determining the correctness of each of a plurality of initial responses to each test question, and in the case of an incorrect response, means for determining if the incorrect response resulted from carelessness, determiner means for detecting each of the student responder's specific deficiencies in past cumulative knowledge or in new subject matter knowledge, analyzer means for identifying each of the responder's specific deficiencies in past cumulative knowledge and in new subject matter knowledge, processing means for summarizing the student responder's knowledge deficiencies, an information storage facility for storing data associated with the test responses, and a report generator for generating written deficiency reports.

### DISCLOSURE OF THE INVENTION

Briefly, and in general terms, the present invention provides a new and improved system and method for diagnosing deficiencies and assessing knowledge in test responses by student responders at the time that the student responder is responding to the test questions. The function of the inventive system and method in the case of a literal incorrect initial response is to simultaneously (a) diagnose, i.e., determine, what specific knowledge deficiencies caused the student responder to be unable to understand the new subject matter presented in the classroom or in an examination by analyzing each literal response to each test question to determine why an error was made, and (b) assess the level of knowledge of the student responder from the responder's answers to the test questions.

In the present invention, a student responder is presented with a series of test probes comprising a plurality of test questions via a computerized testing station. The student responder provides an initial response to each test question by making an appropriate entry in the computerized testing station via a computer keyboard or a mouse. The entry is then transmitted to the system for diagnosing deficiencies in the literal initial response by the student responder in order to determine what specific knowledge deficiencies caused the student responder to be unable to understand the new subject matter. Critical evaluation of the student responder's literal initial response facilitates the assessment of the level of knowledge of the student responder in the relevant subject matter.

In order to accomplish this goal, the first step in the analysis is to determine the correctness of the student responder's literal initial response to each test question of each probe. The determination of the correctness of the student responder's literal initial response is made in an initial response memory/analyzer. The sole function of the initial response memory/analyzer is to determine if the responder's literal initial response is correct or incorrect. This determination is accomplished by a comparator matching procedure that occurs in the memory section of the initial response memory/analyzer. The outcome of this comparator matching procedure is a determination that the student responder's literal initial response to a particular test question is either correct or incorrect. The subsequent analysis and evaluation of the student responder's literal initial response in determining any specific knowledge deficiencies or in assessing the level of the student responder's knowledge in the relevant subject matter is determined by the correctness of the initial response. Thus, the further analysis to which the student responder's initial response is subjected to is determined by whether the initial response is the correct answer or an incorrect answer to the particular test question or questions.

In the case where the initial response memory/analyzer determines that the student responder's literal initial response is incorrect, the inventive system probes the student responder to determine if her incorrect response was due to carelessness. If carelessness was a factor, the student responder may re-address the question. If carelessness was not a factor, the incorrect initial response is transmitted to a necessary knowledge determiner memory/comparator. In accordance with the present invention, all knowledge is based upon subject matter comprised of two components, i.e., (1) past cumulative knowledge and associated rules comprising information that the student responder has already been exposed to, i.e., been taught, and presumed to already understand, and (2) new subject matter knowledge associated with the subject being taught and the rules associated with that new subject matter. The function of the necessary knowledge determiner memory/comparator is to determine whether the error in the student responder's literal initial response was caused by a deficiency in past cumulative knowledge and/or a deficiency in new subject matter knowledge referred to as production rule knowledge. This determination of a deficiency in past cumulative knowledge versus a deficiency in production rule knowledge (i.e., new subject matter knowledge) is accomplished by a comparator matching analysis within a memory section of the necessary knowledge determiner memory/comparator. Once the type of deficiency is determined, the student responder's incorrect initial response is forwarded to other components within the system.

If the necessary knowledge determiner memory/comparator determines that the deficiency in the student responder's incorrect literal initial response is based upon a lack of past cumulative knowledge, the incorrect literal initial response is forwarded to a cumulative knowledge memory/analyzer. The function of the cumulative knowledge memory/analyzer is to analyze the literal incorrect initial response to determine the specific cumulative knowledge rule that the student responder does not understand in view of the incorrect initial response. This function is accomplished by a comparator matching process that occurs within the memory section of the cumulative knowledge memory/analyzer. Likewise, if the necessary knowledge determiner memory/comparator determines that the deficiency in the student responder's literal incorrect initial response is based upon a lack of production rule knowledge (i.e., new subject matter knowledge), the literal initial response is forwarded to a production rule memory/analyzer. The function of the production rule memory/analyzer is to analyze the literal incorrect initial response to determine the specific production rule that the student responder does not understand in view of the literal incorrect initial response. This function is accomplished by a comparator matching process that occurs within the memory section of the production rule memory/analyzer.

Continuing with the case of a literal incorrect initial response, the specific deficient cumulative knowledge rule identified by the cumulative knowledge memory/analyzer and the specific deficient production rule identified by the production rule memory/analyzer are each transmitted to a subject matter processor. The subject matter processor serves to process, organize and summarize the specific deficiencies of the student responder according to past cumulative knowledge and production rule knowledge categories. The summarized deficiency information is then permanently stored within an information storage facility and can be accessed and retrieved for future reference. The summarized deficiency information is also transmitted to a report generator which includes a printer that provides a written deficiency report for review. It is also noted that in the situation involving an incorrect initial response from the student responder, both the production rule memory/analyzer and the cumulative knowledge memory/analyzer exchange inputs with an answer area. In order for the test to continue, the correct answer (to an incorrectly answered test question) must be provided to the student responder to assist her in answering the next test question. The answer area cooperates with the testing station to facilitate the solution to the test question, i.e., the answer area provides a correct answer to the test question at the testing station in response to the student responder's incorrect initial response.

In the case where the initial response memory/analyzer determines that the student responder's literal initial response to a test question is correct, the student responder's literal correct initial response is forwarded directly to the production rule memory/analyzer. The initial response memory/analyzer notifies the production rule memory/analyzer that the student responder's literal initial response is correct. Thus, the production rule memory/analyzer determines that the student responder is knowledgeable of the relevant production rule related to that specific test question. The production rule memory/analyzer then transmits the student responder's literal correct initial response to the subject matter processor, information storage facility and report generator as explained immediately above.

In a preferred embodiment, the system and method for diagnosing deficiencies and assessing knowledge in test responses in its most fundamental form comprises a computerized testing station for presenting a probe comprising multiple questions to a responder. An initial response analyzer communicates with the testing station for determining the correctness of each of a plurality of literal responses by the responder to each question of the probe. A necessary knowledge determiner is disposed to analyze each literal incorrect response to each question of the probe from the initial response analyzer with a first comparator matching memory having a stored list of possible incorrect responses for detecting each of responder's specific deficiencies in past cumulative knowledge and in new subject matter knowledge. A cumulative knowledge analyzer is provided for analyzing each of the literal incorrect responses to each question of the probe with a second comparator matching memory having a stored list of possible incorrect responses for identifying each of the specific deficiencies in past cumulative knowledge, wherein each literal incorrect initial response to each question of the probe results from one of the specific deficiencies. A production rule analyzer is provided for analyzing each of the literal incorrect responses to each question of the probe with a second comparator matching memory having a stored list of possible incorrect responses for identifying each of the specific deficiencies in new subject matter knowledge, wherein each literal incorrect response to each question of the probe results from one of the specific deficiencies. Finally, a report generator communicates with the cumulative knowledge analyzer and the production rule analyzer for generating a written deficiency report for identifying each of the specific deficiencies resulting in the literal incorrect initial responses to the multiple questions of the probe.

These and other objects and advantages of the present invention will become apparent from the following more detailed description, taken in conjunction with the accompanying drawings which illustrate the invention, by way of example.

### BRIEF DESCRIPTION OF THE DRAWINGS

FIG. 1 is a front perspective view of a system and method for diagnosing deficiencies and assessing knowledge in a responder's test responses of the preferred embodiment of the present invention showing a computerized testing station including a monitor for viewing a plurality of test questions of a probe, a microprocessor, and a keyboard and mouse for a student responder to enter responses to the test questions.

FIG. 2 is a generalized block diagram of the system and method for diagnosing deficiencies and assessing knowledge in a responder's test responses of FIG. 1 showing the test questions and responder's answers being entered into a testing computer, the responder's literal responses then being subjected to the system for diagnosing deficiencies in the responder's understanding of the subject matter.

FIG. 3 is a detailed block diagram of the system and method for diagnosing deficiencies and assessing knowledge in a responder's test responses of FIG. 1 where the responder's literal response is an incorrect response, the system including components for determining if responder's deficiency is in required past cumulative knowledge or in newly presented subject matter, and for the subsequent generation of a written report.

FIG. 4 is a detailed block diagram of the system for diagnosing deficiencies and assessing knowledge in a responder's test responses of FIG. 1 where the responder's literal response is a correct response, the system including components for verifying the correctness of the response and for the generation of a written report.

### DETAILED DESCRIPTION OF THE INVENTION

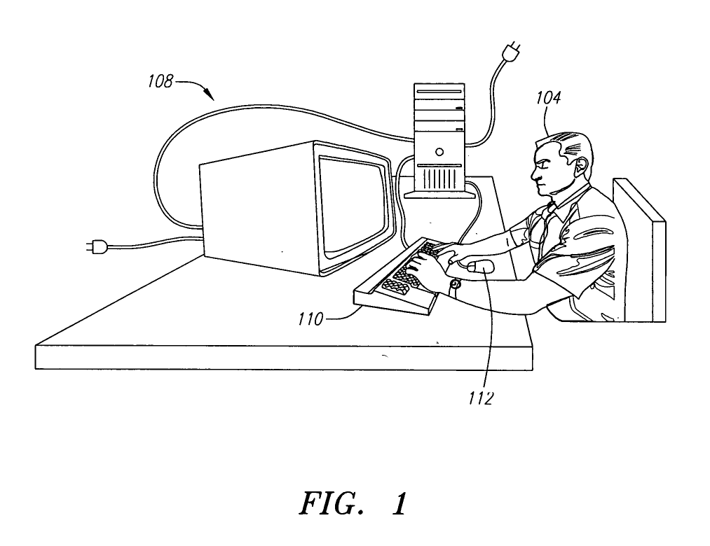

The present invention is a system and method 100 for diagnosing deficiencies and assessing knowledge in a plurality of test responses 102 typically used in testing a student responder 104 in subject matter in an academic or business environment at the time that the student responder 104 is responding to a plurality of test probes or questions 106 as is shown in FIGS. 1-4. However, it is noted that the present invention can be employed in any testing environment where a responder's command of subject matter is being evaluated. The primary function of the inventive system and method 100 in the case of a literal incorrect initial test response 102 is to simultaneously (a) diagnose, i.e., determine, what specific knowledge deficiencies caused the student responder 104 to be unable to understand the relevant subject matter presented in a classroom or in an examination by analyzing each answer or literal initial test response 102 to each test probe or question 106 to determine what or which error was made, and (b) assess the level of knowledge of the student responder 104 based upon her initial test responses 102 to the test probes or questions 106.

In the present invention, the student responder 104 is presented with a series of the test probes or questions 106 via a computerized testing station 108 as shown in FIG. 1. The test probes 106 may include a single or a plurality of test questions. It is noted that the computerized testing station 108 can be a stand-alone computer system normally utilized to test the student responder 104, or in the alternative, it can be connected to the Internet (not shown) as a means for accessing the system 100 via a suitable website. Thus, the student responder 104 can access the system 100 “on-line” from any computer suitably connected to the Internet (not shown). Therefore, the computerized testing station 108 can be located at (a) any authorized school testing facility, or (b) any alternative location including the residence of the student responder 104 which includes a computer system connected to the Internet (not shown).

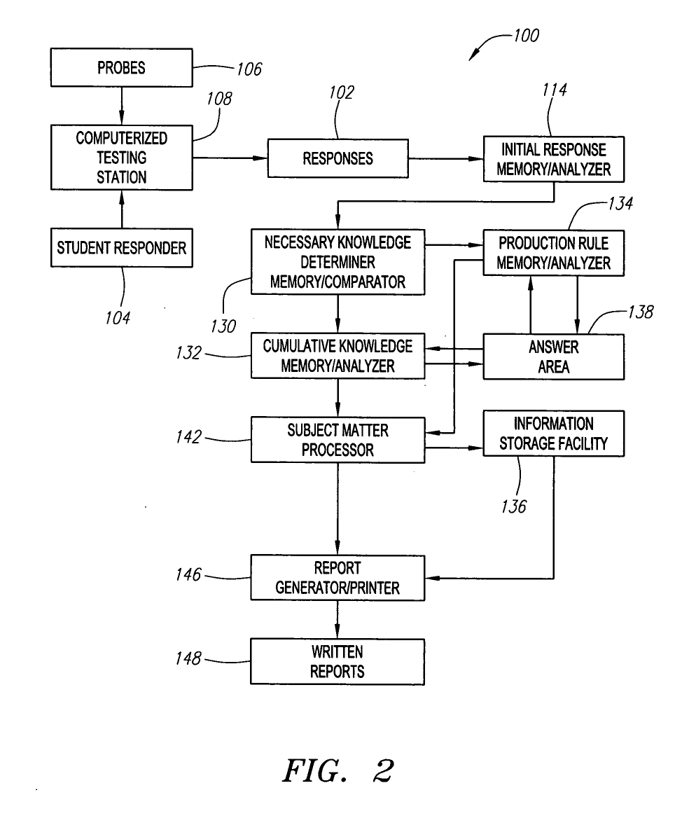

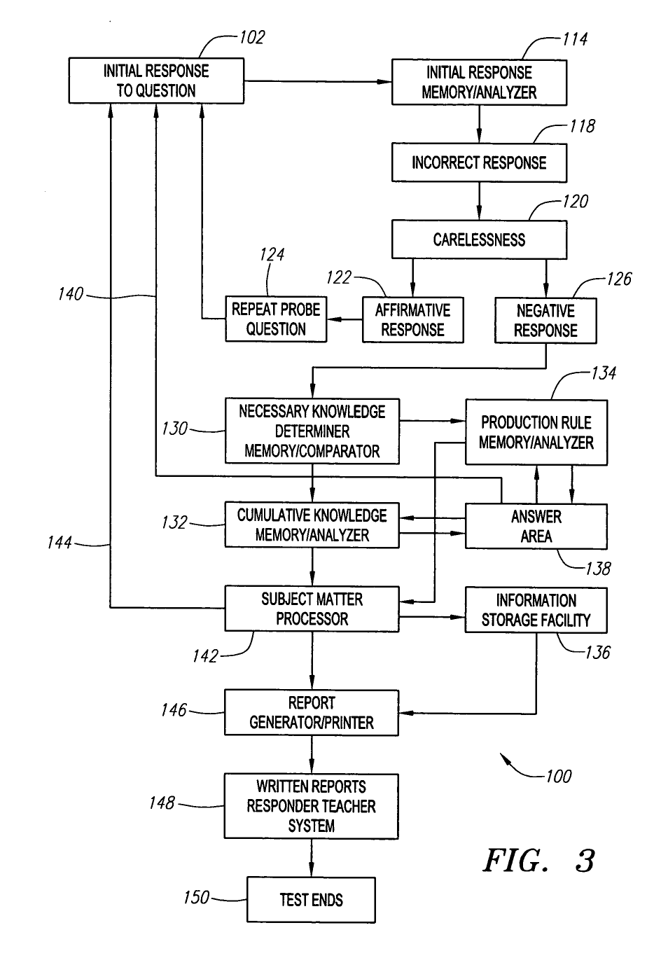

Upon the presentation of the test probe or question 106, the student responder 104 provides an literal initial test response 102 to each test probe or question 106 by making an appropriate entry at the computerized testing station 108 via a computer keyboard 110 or a mouse 112 as shown in FIG. 1. The entry is then transmitted to the system 100 as shown in FIG. 2 for evaluation of the correctness of the literal initial response 102. In the case of an incorrect initial response 102 by the student responder 104, the inventive system 100 functions to diagnose deficiencies in the literal initial test response 102 in order to determine what specific knowledge deficiencies caused the student responder 104 to be unable to understand the relevant subject matter. Critical evaluation of each of the literal incorrect initial test responses 102 by the system 100 facilitates the assessment of the level of knowledge of the student responder 104 in the relevant subject matter as is shown in FIGS. 2-3. In the case of a correct initial test response 102 by the student responder 104 to a test probe or question 106, the system 100 functions to verify the correctness of the literal initial response 102 and to advance to the next question in the test probe 106. In this manner, the system 100 continues the test on to the next test probe 106 or until the completion of the test.

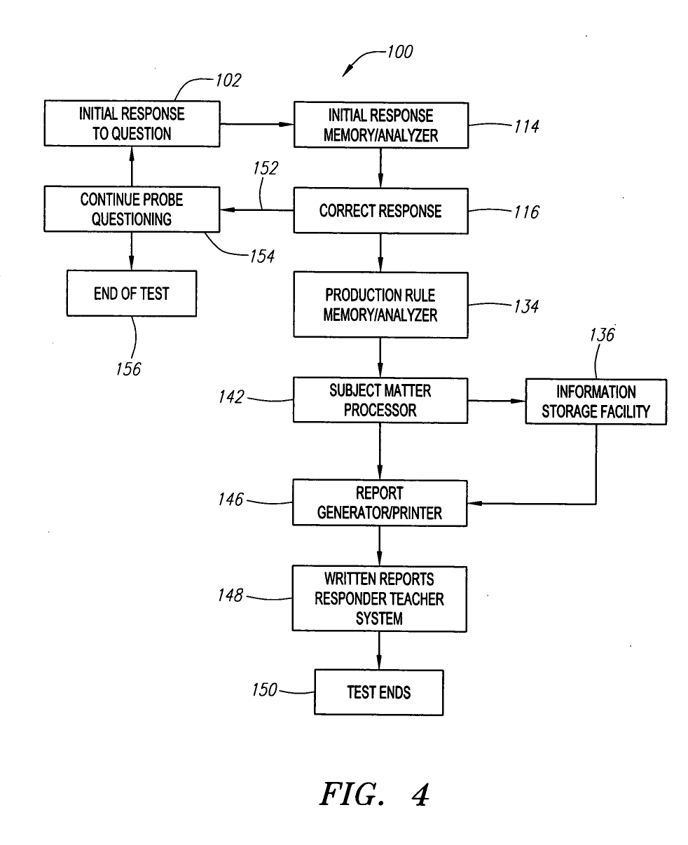

The test probes 106 are delivered to the computerized testing station 108 and the student responder 104 provides a literal initial response 102 to each of the test probes or questions 106 via the keyboard 110 or mouse 112 as shown in FIGS. 1 and 2. The initial test response 102 is then shown being transmitted to an initial response memory/analyzer 114 in FIGS. 2, 3 and 4. It is noted that the operation of the system and method 100 for diagnosing deficiencies and assessing knowledge of the test responses 102 is identical to this point in the description notwithstanding whether the student responder's initial test response 102 is correct or incorrect. The situation where the initial test response 102 to the test probe or question 106 provided by the student responder 104 is incorrect is shown in FIGS. 2 and 3. In the alternative, the situation where the initial test response 102 provided by the student responder 104 is correct is shown in FIG. 4. We will initiate the discussion of the present invention by initially addressing the situation where the student responder provides an incorrect initial test response 102 as shown in FIGS. 2 and 3.

Each literal initial test response 102 to each test probe or question 106 is initially received by the initial response memory/analyzer 114 from the computerized testing station 108 as shown in FIGS. 2 and 3. The first step in the analysis is to determine the correctness of the literal initial response 102 to each test probe or question 106 provided by the student responder 104. The determination of the correctness of the initial response 102 provided by the student responder 104 is made by the initial response memory/analyzer 114. The sole function of the initial response memory/analyzer 114 is to determine whether the literal initial response 102 to the test probe or question 106 provided by the student responder 104 is correct or incorrect. This determination selects the mode of the system 100, i.e., (1) an analysis of a literal initial test response 102 that is incorrect leading to a determination as to what specific deficiencies prevented the student responder from understanding the subject matter being taught (in other words what the student responder 104 does not know), or (2) the verification of an initial test response 102 that is correct and a conclusion that the student responder understands the past cumulative knowledge and production rule associated with the subject matter being taught. The system 100 of the present invention applies a unique analysis to the diagnosis of unlearned knowledge by addressing what past and new information has a student responder 104 not learned that is preventing her from learning new information. The system 100 focuses on each literal initial response 102 of each question within each probe 106 to determine what the student responder 104 has not learned regarding the new subject matter, not just that she has not mastered the new subject matter.

The only function of the initial response memory/analyzer 114 is to determine whether the literal initial response 102 provided by the student responder 104 is correct or incorrect. This determination is made in the following manner. The memory section of the initial response memory/analyzer 114 is a data storage memory containing all the correct responses or answers to all the test probes or questions 106 set forth in the test. Thus, the memory section of the initial response analyzer 114 contains only the correct answers to the test probes or questions 106, i.e., not incorrect answers, because it does not analyze beyond whether the student response 104 is correct or not. Consequently, the correctness of the initial response 102 provided by the student responder 104 is determined by a comparator matching procedure that occurs within the memory section of the initial response memory/analyzer 114. When an initial response 102 is received from the computerized testing station 108, the initial response 102 is literally compared with the correct response data stored in the memory section of the initial response memory/analyzer 114. If the received initial response 102 matches a correct answer to the probe 106 stored in the memory section of the initial response memory/analyzer 114, it is presumed that the initial response 102 is a correct response 116 and the system 100 adopts the mode as shown in FIG. 4.

However, if no corresponding match is discovered between the received literal initial response 102 provided the student responder 104 and the correct answer to the test probe or question 106 stored in the memory section of the initial response memory/analyzer 114, an incorrect response 118 results. However, the incorrect response 118 might be a discrepancy due to carelessness (indicated by number 120 on FIG. 3) on the part of the student responder 104. The initial response memory/analyzer 114 will determine if the incorrect response 118 was due to carelessness 120 by automatically submitting an additional probe or question 106 to the student responder 104. If it is established that the student responder 104 committed a careless error indicated by an affirmative response 122 on FIG. 3, she will be afforded an opportunity to re-answer the original probe or question 106, i.e., the probe or question 106 will be repeated (as indicated by the numeral 124 on FIG. 3). This will be the only additional opportunity for the student responder 104 to correct her error. If the student responder 104 makes yet another error, the second error response will be recorded as an incorrect response 118 by the initial response memory/analyzer 114. If it is established that the student responder 104 was not careless (indicated by a negative response 126 shown on FIG. 3), i.e., she believed that she correctly answered the original probe or question 106, then the literal initial response 102 will be deemed an incorrect response 118. Under these conditions, the system 100 adopts the mode shown in FIG. 3 for an incorrect response 118. Once the system 100 determines that the initial response 102 by the student responder 104 is an incorrect response 118 (either by carelessness 120 or by a genuine lack of knowledge of the subject matter indicated by the negative response 126), the analytical portion of the system 100 is actuated.

The outcome of the comparator matching function of the initial response memory/analyzer 114 is a determination that the initial response 102 by the student responder 104 to a particular test probe or question 106 is either a correct response 116 or an incorrect response 118. The subsequent analysis and evaluation of the initial response 102 provided by the student responder 104 in determining any specific knowledge deficiencies or in assessing the level of the knowledge of the student responder 104 in the relevant subject matter is determined by the correctness of the initial response 102. Thus, the further analysis to which the initial response 102 provided by the student responder 104 is subjected is determined by whether the literal initial response 102 is a correct response 116 or an incorrect response 118 to the particular test probes or questions 106.

In the situation of an incorrect response 118 to a particular test probe or question 106, that literal incorrect response 118 will be forwarded to a necessary knowledge determiner memory/comparator 130 (via the block entitled negative response 126 associated with the issue of carelessness 120 by the student responder 104) as shown in FIG. 3. This action results notwithstanding whether the literal incorrect response 118 provided by the student responder 104 was (1) due to a lack of understanding of the subject matter of the test probe or question 106, or (2) due to repeated carelessness 120 as shown in FIG. 3. The end result is that all negative responses 126 caused by an incorrect response 118 are directed to the necessary knowledge determiner memory/comparator 130 which is the receptacle for all incorrect responses 118. In accordance with the present invention, all knowledge is based upon subject matter comprised of two components, i.e., (1) past cumulative knowledge and associated rules comprising information that the student responder 104 has already been exposed to, i.e., been taught, and presumed to already understand, and (2) new subject matter knowledge associated with the subject being taught and the rules associated with that new subject matter. Thus, there is a distinction between past cumulative knowledge and new subject matter knowledge (also referred to as production rule knowledge in this specification).

The function of the necessary knowledge determiner memory/comparator 130 is to determine whether the error in the literal incorrect response 118 provided by the student responder 104 was caused by a specific deficiency in past cumulative knowledge and/or a specific deficiency in production rule knowledge (i.e., new subject matter knowledge). This determination of a deficiency in past cumulative knowledge versus a deficiency in production rule knowledge (i.e., new subject matter knowledge) is accomplished by a comparator matching analysis within a memory section of the necessary knowledge determiner memory/comparator 130 as shown in FIG. 3. The necessary knowledge determiner memory/comparator 130 compares and analyzes each literal incorrect response 118 to determine whether the specific deficiency in the understanding by the student responder 104 is in past cumulative knowledge or production rule knowledge (i.e., new subject matter knowledge). In general, this is accomplished by matching the literal incorrect response 118 against a storage data bank of all possible responses, i.e., in the memory section of the necessary knowledge determiner memory/comparator 130. Each possible response stored in the data bank represents a response that could be arrived at by the student responder 104 only by making a specific error in past cumulative knowledge or in production rule knowledge. Further, each of the possible responses stored in the memory section of the necessary knowledge determiner memory/comparator 130 is identified as a past cumulative knowledge deficiency or a production rule knowledge deficiency. Once the type of deficiency is determined, the literal incorrect response 118 provided by the student responder 104 is forwarded on to other components within the system 100 to determine, with particularity, what specific deficiencies exist in past cumulative knowledge and/or production rule knowledge (i.e., new subject matter knowledge).

When the initial response memory/analyzer 114 identifies a literal incorrect response 118, and the literal incorrect response 118 is not due to carelessness 120, then the negative response 126 is transmitted to the necessary knowledge determiner memory/comparator 130. Each conceivable incorrect response 118 is stored in the memory section of the necessary knowledge determiner memory/comparator 130 and each literal incorrect response 118 has been pre-analyzed to indicate what type of deficiency exists in that particular incorrect response 118. Thus, the literal incorrect response 118 itself suggests that the deficiency is in past cumulative knowledge or in production rule knowledge (i.e., new subject matter knowledge), or both. When the necessary knowledge determiner memory/comparator 130 discovers a match between a particular literal incorrect response 118 provided by the student responder 104 and the incorrect response data stored in the memory section therein, the stored incorrect response data is identified along with the corresponding deficiencies, i.e., assigned errors, in past cumulative knowledge and/or in production rule knowledge (i.e., new subject matter knowledge). Thus, each particular incorrect response 118 stored in the memory section of the necessary knowledge determiner memory/comparator 130 has associated with it the deficiency or assigned error (i.e., the knowledge that the student responder 104 is lacking) that initially lead the student responder 104 to the incorrect response 118. It is the necessary knowledge determiner memory/comparator 130 that determines from the literal incorrect response 118 whether the deficiency or assigned error is in past cumulative knowledge or in production rule knowledge (i.e., new subject matter knowledge). After the type of deficiency is determined, the literal incorrect response 118 provided by the student responder 104 is forwarded on to a cumulative knowledge memory/analyzer 132 or to a production rule memory/analyzer 134, or in rare cases, to both.

If the necessary knowledge determiner memory/comparator 130 determines that the deficiency in the literal incorrect response 118 provided by the student responder 104 is based upon a lack of past cumulative knowledge, the literal incorrect response 118 is forwarded to the cumulative knowledge memory/analyzer 132 as shown in FIGS. 2 and 3. The function of the cumulative knowledge memory/analyzer 132 is to analyze the literal incorrect response 118 to determine the specific cumulative knowledge rule, i.e., the definitive knowledge, that the student responder 104 does not understand in view of the literal incorrect response 118. This process begins with the cumulative knowledge memory/analyzer 132 analyzing the literal incorrect response 118. This function is accomplished by a comparator matching process that occurs within a memory section of the cumulative knowledge memory/analyzer 132 by inquiring into, i.e., questioning, the most rudimentary area of the appropriate knowledge base. The memory section of the cumulative knowledge memory/analyzer 132 includes therein a stored list of incorrect responses which would result from certain errors committed by the student responder 104. These errors are the result of deficiencies attributed to the student responder 104 in past cumulative knowledge. Thus, these deficiencies or errors are associated with or assigned to the corresponding incorrect responses 118 stored in the memory section of the cumulative knowledge memory/analyzer 132.

During the comparator matching process, a specific literal incorrect response 118 provided by the student responder 104 that is deficient in past cumulative knowledge is compared with the data stored in the memory section of the cumulative knowledge memory/analyzer 132. If the specific incorrect response 118 provided by the student responder 104 is matched to a corresponding incorrect response data stored in the memory section of the cumulative knowledge memory/analyzer 132, the deficiencies or errors associated with or assigned to the stored incorrect response data are disclosed. In this manner, the cumulative knowledge memory/analyzer 132 reveals the cumulative knowledge rule that the student responder 104 is assumed to have been taught but actually does not understand. By associating a possible list of deficiencies or errors with each possible incorrect response data stored in the memory section, the cumulative knowledge memory/analyzer 132 is capable of identifying the relevant deficiencies or errors when a match to the incorrect response 118 provided by the student responder 104 is discovered in the memory section. An error assigned to an incorrect data response stored in the memory section of the cumulative knowledge memory/analyzer 132 will reveal the deficiency in past cumulative knowledge as shown in FIG. 3, or in the alternative, will reveal a confirmation of correctness if the student response 104 is a correct response 116 as shown in FIG. 4.

The cumulative knowledge memory/analyzer 132 will not analyze the incorrect response 118 until the necessary knowledge determiner memory/comparator 130 has determined that the deficiency is in past cumulative knowledge. Once the deficiency in past cumulative knowledge of a literal incorrect response 118 has been identified, the level of inquiry into the deficiency by the cumulative knowledge memory/analyzer 132 is very detailed. The following is offered by way of example and not by limitation. Assuming the subject matter is directed to mathematics, the inquiry might include questions beginning with the general and progressing to the specific. Suppose that the comparator matching procedure which compares the literal incorrect response 118 provided by the student responder 104 with the incorrect response data stored within the memory section of the cumulative knowledge memory/analyzer 132 determines that the primary deficiency is in algebra or arithmetic. This determination is made by the discovery of a matching response in the stored response data of the memory section having that deficiency or error assigned to the matching response. The comparator matching procedure continues to probe the incorrect response 118 and discovers that a secondary deficiency is that the student responder 104 does not understand adding and subtracting negative numbers. A third deficiency is determined to be that the student responder 104 does not understand place value or the subtraction tables. Finally, a fourth deficiency of the student responder 104 is determined to be the misunderstanding of number values. In this manner, the literal incorrect response 118 provided by the student responder 104 is analyzed for deficiencies in past cumulative knowledge in much greater detail than ever before. This portion of the inventive system 100 provides a unique analysis for diagnosing past cumulative knowledge that is preventing the student responder 104 from learning production rule knowledge (i.e., new subject matter knowledge).

There may be a situation in which the student responder 104 provides a literal incorrect response 118 that has been determined by the necessary knowledge determiner memory/comparator 130 to include a deficiency in past cumulative knowledge, and that the literal incorrect response 118 is entirely inconsistent with the corresponding test probe or question 106. In this situation, it may be desirable to directly interrogate the student responder 104 with an additional test probe or question 106 to verify that the student understands the basic subject matter. For example, suppose that the initial test probe or question 106 involved the multiplication of (3×5). Further, suppose that the answer supplied by the student responder 104 is the number 2 which is entirely incorrect and in this case is deemed to be a deficiency in past cumulative knowledge. At this point, it is determined that the student responder 104 should be directly interrogated with an additional related test probe 106 to determine if the student responder 104 understands the multiplication tables. The additional related test probe 106 would be generated by the system 100 and appear on the monitor screen of the computerized testing station 108. The student responder 104 would then respond to the additional related test probe 106 via the keyboard 110 as shown in FIG. 1. The cumulative knowledge memory/analyzer 132 receives the answer to the additional test probe 106 provided by the student responder 104. The answer supplied by the student responder 104 to the additional related test probe 106 would then be compared to the incorrect response data stored in the memory section of the cumulative knowledge memory/analyzer 132. In this manner, the past cumulative knowledge of the student responder 104 concerning the multiplication tables can be determined which will assist in the determination as to why the answer to the initial test probe 106 of the multiplication of (3×5) was entirely incorrect.

If the necessary knowledge determiner memory/comparator 130 determines that the deficiency in the literal incorrect response 118 provided by the student responder 104 is based upon a lack of production rule knowledge (i.e., new subject matter knowledge), the literal incorrect response 118 is forwarded to the production rule memory/analyzer 134 as shown in FIGS. 2 and 3. The function of the production rule memory/analyzer 134 is to analyze the literal incorrect response 118 to determine the specific production rule knowledge, i.e., new subject matter knowledge, that the student responder 104 does not understand in view of the literal incorrect response 118. This process begins with the production rule memory/analyzer 134 analyzing the incorrect response 118. This function is accomplished by a comparator matching process that occurs within a memory section of the production rule memory/analyzer 134 by inquiring into, i.e., questioning, knowledge specific to the appropriate production rule. This questioning facilitates the determination of whether the student responder 104 understands the production rule portion of the test probe or question 106 that is necessary to arrive at the correct response 116. The memory section of the production rule memory/analyzer 134 includes therein a stored list of possible incorrect responses which would result from certain errors committed by the student responder 104. These errors are the result of deficiencies attributed to the student responder 104 in production rule knowledge. The possible stored incorrect responses are associated with the possible misunderstanding that the student responder 104 may have in regard to the particular production rule. Thus, these specific deficiencies or errors are associated with or assigned to the corresponding incorrect responses stored in the memory section of the production rule memory/analyzer 134 which will analyze the assigned error according to the elements of the production rule and define which particular portion of the rule that the student responder 104 does not understand.

During the comparator matching process, a specific literal incorrect response 118 provided by the student responder 104 that is deficient in production rule knowledge (i.e., new subject matter knowledge) is compared with the data stored in the memory section of the production rule knowledge memory/analyzer 134, i.e., matched against all possible stored incorrect responses. If the specific literal incorrect response 118 provided by the student responder 104 is matched to a corresponding incorrect response data stored in the memory section of the production rule memory/analyzer 134, the deficiencies or errors associated with or assigned to the stored incorrect response data are disclosed. In this manner, the production rule memory/analyzer 134 reveals the production rule that the student responder 104 is assumed to have been taught but actually does not understand. By associating a possible list of deficiencies or errors with each possible incorrect response data stored in the memory section, the production rule memory/analyzer 134 is capable of identifying the relevant deficiencies or errors when a match to the literal incorrect response 118 provided by the student responder 104 is discovered in the memory section. An error assigned to an incorrect data response stored in the memory section of the production rule memory/analyzer 134 will reveal the specific deficiency in production rule knowledge as shown in FIG. 3, or in the alternative, will reveal a confirmation of correctness if the student response 104 is a correct response 116 as shown in FIG. 4.

The production rule memory/analyzer 134 will not analyze the incorrect response 118 until the necessary knowledge determiner memory/comparator 130 has determined that the deficiency is in production rule knowledge. Once the deficiency in production rule knowledge of a literal incorrect response 118 has been identified, the level of inquiry into the deficiency by the production rule memory/analyzer 134 is very detailed. The following is offered by way of example and not by limitation. Assuming that the analysis addresses the rules of any relevant subject matter (i.e., mathematics, grammar, etc.), the inquiry might include questions beginning with the general and progressing to the specific. Suppose that the comparator matching procedure which compares the literal incorrect response 118 provided by the student responder 104 with the incorrect response data stored within the memory section of the production rule memory/analyzer 134 determines that the primary deficiency is identified by analyzing whether the student responder 104 has violated the primary production rule. The primary production rule might be directed toward a category of mathematics such as algebra or arithmetic. This determination is made by the discovery of a matching response in the stored response data of the memory section having that deficiency or error assigned to the matching response. The comparator matching procedure will continue to probe the literal incorrect response 118 to determine if a secondary deficiency exists by analyzing whether the student responder 104 has violated an element within the applicable production rule. A third deficiency might be determined by analyzing whether the student responder 104 has violated rules governing an element within a particular production rule. A fourth or further deficiency might be determined by analyzing the literal incorrect response 118 regarding any other applicable violations. In this manner, the literal incorrect response 118 provided by the student responder 104 is analyzed for deficiencies in production rule knowledge in much greater detail than ever before. This portion of the inventive system 100 provides a unique analysis for diagnosing a lack of understanding in production rules that is preventing the student responder 104 from acquiring production rule knowledge (i.e., new subject matter knowledge).

A situation can also exist in which the student responder 104 provides a literal incorrect response 118 that has been determined by the necessary knowledge determiner memory/comparator 130 to include a deficiency in production rule knowledge, and that the literal incorrect response 118 is entirely inconsistent with the corresponding test probe or question 106. In this situation, it may be desirable to directly interrogate the student responder 104 with an additional test probe or question 106 to verify that the student understands the production rule. For example, suppose that the initial test probe or question 106 involved the multiplication of (23×25). Further, suppose that the answer supplied by the student responder 104 is the number 2 which is entirely incorrect and in this case is deemed to be a deficiency in production rule knowledge. At this point, it is determined that the student responder 104 should be directly interrogated with an additional related test probe 106 to determine if the student responder 104 understands the production rules associated with this multiplication. The additional related test probe 106 would be generated by the system 100 and appear on the monitor screen of the computerized testing station 108. The student responder 104 would then respond to the additional related test probe 106 via the keyboard 110 as shown in FIG. 1. The production rule memory/analyzer 134 receives the answer to the additional related test probe 106 provided by the student responder 104. The answer supplied by the student responder 104 to the additional related test probe 106 would then be compared to the incorrect response data stored in the memory section of the production rule memory/analyzer 134. In this manner, the production rule knowledge of the student responder 104 concerning the production rules for multiplication can be determined which will assist in the determination as to why the answer to the initial test probe 106 of the multiplication of (23×25) was entirely incorrect.

In general, the analyzation, i.e., the method of inquiry, in determining what the specific deficiencies or assigned errors are that are associated with the literal incorrect response 118 provided by the student responder 104 is most often by comparing the literal incorrect response 118 with the incorrect response data stored in the memory section of (1) the cumulative knowledge memory/analyzer 132, and/or (2) the production rule memory/analyzer 134. As previously described, this determination is made by the comparison matching process between the literal incorrect response 118 provided by the student responder 104 with the incorrect response data stored in the memory section having that specific deficiency or error assigned to the matching response. A suitable match enables the determination of the identity of the specific deficiency or assigned error. However, there are situations when there is more than one possible cause for the deficiency or assigned error, a situation distinguishable from previous examples set forth herein. Under these conditions, the cumulative knowledge memory/analyzer 132 or the production rule memory/analyzer 134 must quiz the student responder 104 on each alternative cause for the incorrect response 118 to discover the specific deficiency. In general, this quiz is not accomplished by asking questions, written or oral, but rather by presenting via the computerized testing station 108 (shown in FIG. 1) an additional quick probe or question 106 for each error. Once the student responder 104 answers the probe or question 106, the cumulative knowledge memory/analyzer 132 will more accurately determine the cause of the original error.

For example, it may be desirable to have the system 100 interrogate the student responder 104 to verify the error that has occurred. Suppose that the probe or question 106 presented to the student responder 104 is the multiplication of (23×25). If the multiplication is completed correctly, the first step would be to multiply the “3” in the number “23” by the “5” in the number “25” which would result in the product “15”. Now suppose that the answer provided by the student responder 104 to the first step in the multiplication (23×25) is the number “8” instead of the product “15”. Since the number “8” is not the correct answer to the first step of this multiplication, the system 100 must inquire into what error the student responder 104 has committed. The system 100 will present an additional test probe or question 106 on the monitor screen of the computerized testing station 108 shown in FIG. 1 directed to the student responder 104. The system 100 might inquire whether the student responder 104 added the “3” in the number “23” to the “5” in the number “25” instead of multiplying them. The student responder 104 can then type a “yes” or “no” answer in response to the probe or question 106 by utilizing the keyboard 110. If the student responder 104 types the answer “yes”, the system 100 notifies the production rule memory/analyzer 134 that the student responder 104 does not understand the relevant production rule relating to the multiplication tables. However, if the student responder 104 types the answer “no”, the system 100 must then continue to analyze the incorrect response 118. In this situation, the deficiency exhibited by the student responder 104 directed to the multiplication tables is summarized with other deficiency data for inclusion into a report as is explained herein below.

Continuing with the explanation of a literal incorrect response 118 provided by the student responder 104, both the cumulative knowledge memory/analyzer 132 and the production rule memory/analyzer 134 each exchange reciprocal connections with an answer area 138 as shown in FIGS. 2 and 3. Once a literal incorrect response 118 has been identified by the initial response memory/analyzer 114 and the cumulative knowledge memory/analyzer 132 and the production rule memory/analyzer 134 have identified the relevant deficiency or assigned error for a test probe or question 106, it is necessary for the correct answer to be supplied to the student responder 104. Keeping in mind that the student responder 104 provided the literal incorrect response 118, the correct answer to the incorrectly answered test probe or question 106 must be provided to the student responder 104 to assist her in answering the next test probe or question 106. This action is necessary in order to continue the test. Notwithstanding the student responder 104 has provided a literal incorrect response 118, it is desirable that she continue to respond to the remaining probes or questions 106 in the test The answer area 138 cooperates with the computerized testing station 108 to facilitate the solution to the test probe or question 106. This is accomplished by enabling the answer area 138 to provide the correct answer to the test probe or question 106 at the testing station 108 as a result of the incorrect response 118 provided by the student responder 104. Thus, the answer area 138 can be defined as a neutral area location in which the cumulative knowledge memory/analyzer 132 and the production rule memory/analyzer 134 provide the correct answers to the test probes or questions 106. These correct answers must necessarily be provided to enable the student responder 104 to successfully complete the test, i.e., to provide the student responder 104 with the answer to the most recent test probe or question 106 so that she can advance to the next test probe or question 106.

Some test probes or questions 106 require multiple responses to provide the correct answer, i.e., a test probe 106 may appear to require one answer but might require two or more responses to correctly provide the one answer. The purpose of the answer area 138 is to provide the neutral area for the answer, i.e., an area in which the initial part of the answer can be provided to the student responder 104 without supplying more information. This enables the student responder 104 to construct the answer one step at a time with the correct answer to each step being provided to her if one of her responses is an incorrect response 118. As the answer to the test probe 106 is constructed one step at a time, the student can place each of the multiple responses in its proper place on the computerized testing station 108 during the calculation thereby acknowledging that she knows the production rule for place value and placement of the numbers. This design facilitates the further testing of the student responder 104 in that the cumulative knowledge memory/analyzer 132 and the production rule memory/analyzer 134 continue to monitor the initial responses of the student responder 104 for deficiencies or assigned errors. This design further explains the reciprocal connections between (1) the cumulative knowledge memory/analyzer 132 and the answer area 138, and (2) the production rule memory/analyzer 134 and the answer area 138 as shown on FIGS. 2 and 3. This is the case even if the student responder 104 provides a literal incorrect response 118 to more than one question in the probe 106. In this manner, the answer area 138 enables the student responder 104 to continue the examination. This can be accomplished by arranging for the answer area 138 to appear on the monitor screen of the computerized testing station 108. Then, the student responder 104 has ready access to the correct answer as they are made available by the system 100.

The neutral area, defined as an area in which the initial part of the answer to the test probe 106 can be provided to the student responder 104 without supplying more information, is an area separate from the test probe or question 106 which can be located on the monitor screen of the computerized testing station 108. The system 100, when processing for example, a mathematical problem, will not automatically place the correct answer in the proper location in an intervening step during the calculation of the problem solution. This result occurs because the correct answers often require more than one area of knowledge. An example of a mathematical test probe 106 requiring multiple responses to arrive at the correct answer is the multiplication of the numbers 23×45. The first step in this problem is to multiply (5×3) which equals “15”. To arrive at the intermediate answer of “15” requires several areas of knowledge. First, the student responder 104 must have knowledge of the multiplication tables that (5×3) equals “15”. Second, knowledge is required that the “5” in the number “15” must be placed in the column under the numbers “3” and “5” which indicates a knowledge of place value. Third, knowledge is required to understand where to place the number “5” indicates that the student responder 104 understands the rule for number placement. Finally, the fourth step requires understanding the rule that the “1” in the number “15” must be placed above the “2” of the number “23”. The student responder 104 may know some of these rules but not all of them.

In accordance with the present invention, the answer area 138 will initially place the number “5” in the neutral area so as not to provide a prompt to the student responder 104 as to the proper location of the number “5” in the problem solution. This action advises the student responder 104 of the correct answer to this intermediate step but does not provide the answer, i.e., indicate, whether the student responder 104 has knowledge of place values, placement in the problem solution, etc. Then the student responder 104 will place the number “5” in the proper location within the solution to the test probe or question 106 thereby answering the query whether she has knowledge of place value and number placement. In the case where the student responder 104 fails to place the number “5” in the correct location under the numbers “3” and “5” in the problem solution of the initial (3×5) multiplication test probe or question 106, the cumulative knowledge memory/analyzer 132 will conclude that she doesn't have past cumulative knowledge of the multiplication tables, at least not (5×3), but does understand number placement. Thereafter, the number “1” will appear in the answer area 138 and the student responder 104 must demonstrate that she knows to place the “1” above the “2” in the number “23” of the test probe or question 106. If she places the “1” above the “2” in the number “23”, she will be credited with knowing the number placement rule. If she does not place the number “1” in the correct location, i.e., above the “2” in the number “23”, the production rule memory/analyzer 134 will conclude that the student responder 104 does not know the number placement production rule.

At each step, the student responder 104 is notified of the correct answer to the particular question in the probe 106 by oral and written prompts and by the answer appearing in the answer area 138 of the computerized testing station 108. The written prompts reach the student responder 104 during the test through the monitor screen of the computerized testing station while the oral prompts reach the student responder 104 through a plurality of computer speakers (not shown). After the student responder 104 places the answers to the questions of the test probe 106 in the correct location on the computerized testing station 108 and responds to all inquiries, the answer area 138 will notify the initial response memory/analyzer 114 on a line 140 shown in FIG. 3 that the student responder 104 is ready for the next probe or question 106.

The purpose of the test probes or questions 106 is to identify the knowledge which is impeding the student responder 104 from acquiring new information in the classroom or during the test. Note that a probe 106 is typically a combination of many inquiries or questions and a student responder 104 may not know the answer to all the questions in the probe 106. However, this does not mean that she doesn't have knowledge to other questions in the probe 106. If the questioning should stop because the student responder 104 is unable to correctly answer one or more of the questions in the test probe 106, the test would not be completed. The example set out immediately above demonstrates that there is an ongoing communication between (1) the cumulative knowledge memory/analyzer 132 and the answer area 138, and (2) the production rule memory/analyzer 134 and the answer area 138. The answer area 138 is responsive to the cumulative knowledge memory/analyzer 132 since the testing probes 106 must continue so that the student responder 104 can complete the test.

Thus, the reciprocal connectors between the answer area 138 and the cumulative knowledge memory/analyzer 132 shown in FIGS. 2 and 3 facilitate the evaluation of further answers for past cumulative knowledge. Likewise, the answer area 138 is responsive to the production rule memory/analyzer 134 since the testing probes 106 must continue so that the student responder 104 can complete the test. Thus, the reciprocal connectors between the answer area 138 and the production rule memory/analyzer 134 shown in FIGS. 2 and 3 facilitate the evaluation of further answers for production rule knowledge. In this manner, the system 100 continues to analyze deficiencies in the literal incorrect responses 118 provided by the student responder 104. By employing the answer area 138 to provide the correct answers to the student responder 104 (after a literal incorrect response 118 has been provided), the student responder 104 has ready access to the correct answers and the test can continue. This design facilitates the main goal of the system 100 which is to identify the causes of the specific deficiencies of the student responder 104 that prevents the acquisition of new knowledge (not to determine what the student responder 104 already knows, although this is a secondary benefit).

Continuing with the case in which the student responder 104 provides a literal incorrect response 118 to a test probe or question 106, the next stage in the system 100 is a subject matter processor 142. The specific deficient cumulative knowledge rule identified by the cumulative knowledge memory/analyzer 132 and the specific deficient production rule identified by the production rule memory/analyzer 134 are each transmitted to the subject matter processor 142 as shown in FIGS. 2 and 3. The subject matter processor 142 serves to process, organize and summarize the specific deficiencies of the student responder 104 according to the past cumulative knowledge category and the production rule knowledge category. As shown in FIGS. 2 and 3, the subject matter processor 142 receives an input from the cumulative knowledge memory/analyzer 132 and an input from the production rule memory/analyzer 134. The initial analysis conducted on each literal incorrect response 118 is performed by (1) the cumulative knowledge memory/analyzer 132 regarding deficiencies in past cumulative knowledge, and (2) the production rule memory/analyzer 134 regarding deficiencies in production rule knowledge. The subject matter processor 142 provides a processing function, not an analyzing function. Thus, the subject matter processor 142 receives the input directed to deficiencies in past cumulative knowledge and the input directed to deficiencies in production rule knowledge for each student responder 104 and summarizes the information contained in these deficiency inputs for the teacher. Once the cumulative knowledge memory/analyzer 132 and the production rule memory/analyzer 134 each forward the deficiencies in past cumulative knowledge and in production rule knowledge (i.e., new subject matter knowledge), respectively, to the subject matter processor 142, the system 100 will produce another test probe or question 106, or in the alternative, end the test. This is accomplished by the subject matter processor 142 communicating with the system 100 across a line 144 shown in FIG. 3.

Simply stated, the subject matter processor 142 places the results or conclusions regarding specific deficiencies in past cumulative knowledge received from the cumulative knowledge memory/analyzer 132 and the results or conclusions regarding specific deficiencies and acquired knowledge in production rule knowledge received from the production rule memory/analyzer 134 into a useful format presentation for the teacher. For example, suppose that the cumulative knowledge memory/analyzer 132 and the production rule memory/analyzer 134 determine that the student responder 104 does not have knowledge of the multiplication tables for the numbers 5, 8 and 9. The subject matter processor 142 will summarize the data into a format that distinguishes the deficiencies in past cumulative knowledge from the deficiencies in production rule knowledge for use by the teacher. The subject matter processor 142 will then forward the summarized data to an information storage facility 136 for permanent storage as shown in FIGS. 2 and 3. Thus, the subject matter processor 142 is the receptacle that receives the deficiency data and the newly acquired data (i.e., new subject matter knowledge) regarding past cumulative knowledge and production rule knowledge, respectively, then summarizes and places the deficiency data and newly acquired data (i.e., new subject matter knowledge) into a useful format presentation for the teacher. Additionally, the subject matter processor 142 can also recommend that the student responder 104 be assigned to a particular tutoring group or class for re-teaching/remedial purposes and what subject matter should be re-taught.

Thereafter, the summarized deficiency information for each student responder 104 from the subject matter process 142 is then permanently stored within the information storage facility 136 as shown in FIGS. 2 and 3. Thus, the information storage facility 136 is the final data storage memory for the accumulation of the summarized deficiency information concerning each student responder 104. The summarized deficiency information for each student responder 104 can then be accessed and retrieved as required from the information storage facility 136 for immediate and future reference. The summarized deficiency information from the information storage facility 136 and the subject matter processor 142 each provide an input signal to a report generator/printer 146 as shown on FIGS. 2 and 3. The report generator/printer 146 is the component of the system 100 that generates and prints written reports 148 regarding the specific deficiencies in past cumulative knowledge and production rule knowledge for each student responder 104 as is shown in FIGS. 2 and 3. The written reports 148 which can include reports to the student responder 104, teacher reports, system reports and supervisor reports, are then disbursed to authorized personnel. After every question to every probe 106 has been satisfactorily administered to the student responder 106, the test is terminated as indicated by the box labeled test ends 150 on FIG. 3.

During operation of the system and method 100 for diagnosing deficiencies and assessing knowledge in a plurality of test responses 102 when the student responder 104 provides a literal incorrect response 118, the following sequence occurs. The initial response memory/analyzer 114 interrogates the student responder 104 as to whether her literal incorrect response 118 was due to carelessness 120. If the student responder 104 answers that her response was issued in a careless manner, the initial response memory/analyzer 114 will repeat the question as indicated by the box labeled repeat probe question 124 as shown on FIG. 3. However, if the response from the student responder 104 is that she was not careless and she believed that she had responded with the correct answer, then the system 100 will forward her literal incorrect response 118 to the necessary knowledge determiner memory/comparator 130 for analyzation, i.e., identification of the source of the problem. The necessary knowledge determiner memory/comparator 130 will now analyze her literal incorrect response 118 to determine if her literal incorrect response 118 is caused by a lack of cumulative knowledge or production rule knowledge (i.e., new subject matter knowledge). If the necessary knowledge determiner memory/comparator 130 determines that the literal incorrect response 118 is due to a misunderstanding of production rule knowledge, the literal incorrect response 118 will be forwarded to the production rule memory/analyzer 134 for further analyzation. However, if the necessary knowledge determiner memory/comparator 130 determines that the literal incorrect response 118 is due to a lack of cumulative knowledge, then the incorrect response 118 will be forwarded to the cumulative knowledge memory/analyzer 132 for further analyzation.

The cumulative knowledge memory/analyzer 132 initially determines what area of past cumulative knowledge that the student responder 104 is deficient in, i.e., the broadest and most general topic as arithmetic, algebra, geometry. Next, the cumulative knowledge memory/analyzer 132 will determine which aspects of the general topic that the student responder 104 is deficient in, for example, the student responder 104 doesn't understand adding and subtracting negative numbers. Then, the cumulative knowledge memory/analyzer 132 will determine whether the student responder 104 understands the relevant addition and subtraction tables. Finally, the cumulative knowledge memory/analyzer 132 will continue the inquiry until the cause of the error by the student responder 104 is determined. Upon the determination of the cause or causes of the error in past cumulative knowledge, the cumulative knowledge memory/analyzer 132 will provide the correct answer to (1) the answer area 138 to ensure the continuation of the test, and (2) to the subject matter processor 142 for analyzation storage in the information storage facility 136, respectively.

Next, the answer area 138 provides the student responder 104 with the correct answer so that she can answer the next probe or question 106 ensuring that the test will continue. However, sometimes the correct answer requires more than one response. In this case, the answer area 138 provides the first required step to the student responder 104. By determining whether the student responder 104 provides the correct answer to the second step in the test probe or question 106, the answer area 138 will notify the production rule memory/analyzer 134 of the knowledge or ignorance of the student responder 104 of the appropriate production rule. The production rule memory/analyzer 134 will determine from the literal incorrect response 118 whether the student responder 104 is aware of the production rule. If the student responder 104 is knowledgeable of the production rule, the production rule memory/analyzer 134 will forward that information to the subject matter processor 142. If the student responder 104 is not knowledgeable of the relevant production rule, the production rule memory/analyzer 134 will provide the correct answer to the answer area 138 and notify the subject matter processor 142 of the deficiency of the student responder 104.

When the necessary knowledge determiner memory/comparator 130 determines that the literal incorrect response 118 is an error in production rule knowledge, the literal incorrect response 118 will be forwarded to the production rule memory/analyzer 134. The production rule memory/analyzer 134 will then analyze the literal incorrect response 118 and determine the cause of the misunderstanding by the student responder 118. The production rule memory/analyzer 134 will then forward that information to the subject matter processor 142.

The subject matter processor 142 receives and summarizes the deficiency information transmitted from the cumulative knowledge memory/analyzer 132 and the production rule memory/analyzer 134. The summarized deficiency information is then forwarded to the information storage facility 136 for permanent storage and to the report generator/printer 146 for the generating and printing of written reports 148. The written reports 148 are then disbursed in accordance with the desires of the teacher. Once the cumulative knowledge memory/analyzer 132 forwards the deficiencies in past cumulative knowledge to the subject matter processor 142, the subject matter processor 142 via line 144 shown in FIG. 3 will cause the system 100 to produce another probe or question 106, or in the alternative, end the test. Thereafter, the subject matter processor 142 will forward the summarized deficiency information to the information storage facility 136 and the report generator/printer 146.

We now turn our attention to the situation where the student responder 104 provides the correct response 116 to the test probe or question 106. Please refer to FIG. 4 for the description to follow. Note that when a literal correct response 116 is provided by the student responder 104, the components employed to process the correct response 116 vary from those employed when the literal incorrect response 118 is provided. However, with minor exceptions, the components employed during the processing of the literal correct response 116 as shown in FIG. 4 are identical in structure, function and operation to those employed during the processing of a literal incorrect response 118 as shown in FIGS. 2 and 3 and will be referred to with the same identification number.

The student responder 104 is presented with the test probes or questions 106 while seated at the computerized testing station 108 as shown in FIG. 1. The student responder enters her literal initial response 102 at the keyboard 110 or via the computer mouse 112. The initial response 102 to the test probe or question 106 is shown transmitted to the initial response memory/analyzer 114 in FIG. 4. As previously described, the data stored in the memory section of the initial response memory/analyzer 114 includes only correct answers to the test probes or questions 106. Incorrect answers are not included since the initial response memory/analyzer 114 does not analyze or interrogate beyond whether the initial test response 102 is correct or incorrect. Thus, the conclusion drawn from the analysis conducted by the initial response memory/analyzer 114 is that the literal initial response 102 provided by the student responder 104 is either a correct response 116 or an incorrect response 118. The literal initial test response 102 provided by the student responder 104 is then compared with the correct response data stored in the memory section of the initial response memory/analyzer 114. If a match is discovered between the initial test response 102 provided by the student responder 104 and the correct response data stored in the memory section of the initial response memory/analyzer 114, then it is presumed that the student responder 104 has provided the correct response 116 to the test probe or question 106. The presumed correct response 116 is then transmitted on a line 152 to a box labeled continue probe questioning 154 as shown in FIG. 4. In this manner, the initial response memory/analyzer 114 sends a signal to the system 100 that the student responder 104 has properly answered the current test probe or question 106 and that the next test probe or question 106 should be submitted to the student responder 104. If all the questions of all the test probes 106 have been asked and answered, the test ends as indicated by the box labeled end of test 156 on FIG. 4.

The presumed literal correct response 116 is also transmitted from the initial response memory/analyzer 114 directly to the production rule memory/analyzer 134 as shown in FIG. 4 to verify the correctness of the presumed literal correct response 116. The memory section of the production rule memory/analyzer 134 also includes the correct answers to the test probes or questions 106 stored therein. The function of the production rule memory/analyzer 134 in this posture is to accommodate the comparison of the presumed literal correct response 116 provided by the student responder 104 with the correct answer data stored in the memory section of the production rule memory/analyzer 134. If a match is discovered between the presumed literal correct answer 116 provided by the student responder 104 and the correct answer data stored in the memory section of the production rule memory/analyzer 134, the presumed literal correct answer 116 provided by the student responder 104 will be verified. Thus, the production rule memory/analyzer 134 confirms that the presumed literal correct answer 116 is actually correct by matching it against the correct answer data stored in the memory section of the production rule memory/analyzer 134 in a comparison matching process. Once the presumed literal correct answer 116 is verified by the production rule memory/analyzer 134, it is clear that the student responder 104 understands the specific production rule for the particular test probe or question 106. Thus, the production rule memory/analyzer 134 determines that the student responder 104 is knowledgeable of the relevant production rule related to the specific test probe or question 106.

The production rule memory/analyzer 134 then forwards a message or confirmation of correction to the subject matter processor 142 that the student responder 104 is knowledgeable of the production rule necessary to answer the particular test probe or question 106. The subject matter processor 142 serves to provide the same function as in the case of the literal incorrect response 118, i.e., it receives the confirmation of correction for each test probe or question 106 answered correctly (just as it receives the specific deficiencies of the student responder 104 regarding literal incorrect responses 118). Thus, the subject matter processor 142 serves to process, organize and summarize the confirmations of correction for the correct responses 116 provided by the student responder 104. Thereafter, the subject matter processor 142 will then transmit summarized data to the information storage facility 136 for permanent storage and to the report generator/printer 146 which will generate and print the written report 148 for distribution to the appropriate parties as previously explained. The summarized data will include the summarized confirmations of correction for those test probes or questions 106 for which a correct response 116 was received, and the summarized deficiencies for those test probes or questions 106 for which a literal incorrect response 118 was received.

During operation of the system and method 100 for diagnosing deficiencies and assessing knowledge in a plurality of test responses 102 when the student responder 104 provides a literal correct response 116, the following sequence occurs. The initial response memory/analyzer 114 notifies the production rule memory/analyzer 134 that the answer provided by the student responder 104 is a literal correct response 116. The production rule memory/analyzer 134 determines that the student responder 104 is knowledgeable of the particular production rule relative to that particular test probe or question 106 and transmits the confirmation of correction to the subject matter processor 142 as shown in FIG. 4. Thereafter, the subject matter processor 142 transmits the confirmation of correction (regarding the fact that the student responder 104 is knowledgeable of the production rule necessary to answer the particular test probe or question 106) to the information storage facility 136 for permanent storage. The initial response memory/analyzer 114 then causes another question within the test probe 106 to be brought forward or if all the questions within the probe 106 have been answered, the next probe 106 in the test will be introduced. When all the probes 106 within the test have been answered, the initial response memory/analyzer 114 will notify the student responder 104 that the test has ended as indicated by the box labeled end of test 156. The subject matter processor 142 will then transmit the summarized data to the report generator/printer 146 which will generate the written reports 148. The test then ends as is indicated by the box labeled test ends 150.

In a preferred embodiment, the system and method 100 for diagnosing deficiencies and assessing knowledge in test responses in its most fundamental form comprises a computerized testing station 108 for presenting the test probe or question 106 to the student responder 104. The initial response memory/analyzer 114 communicates with the testing station 108 for determining the correctness of each of a plurality of literal initial responses 102 by the student responder 104 to each question of the test probe 106. The necessary knowledge determiner memory/comparator 130 is disposed to analyze each literal incorrect initial response 118 to each question of the probe 106 from the initial response memory/analyzer 114 for identifying specific deficiencies of the student responder 104 in past cumulative knowledge and in new subject matter knowledge. The cumulative knowledge memory/analyzer 132 is provided for analyzing each of the literal incorrect initial responses 118 to each question of the probe 106 for identifying specific deficiencies in past cumulative knowledge where each literal incorrect response 118 to each question of the probe 106 results from one of the specific deficiencies. The production rule memory/analyzer 134 is provided for analyzing each of the literal incorrect initial responses 118 to each question of the probe for identifying specific deficiencies in new subject matter knowledge where each literal incorrect response to each question of the probe 106 results from one of the specific deficiencies. Finally, the report generator/printer 146 communicates with the cumulative knowledge memory/analyzer 132 and the production rule memory/analyzer 134 for generating the written deficiency report 148 for identifying each of the specific deficiencies resulting in the literal incorrect responses 118 to the multiple questions of the probe 106.

The present invention provides novel advantages over other systems and/or methods for evaluating student testing procedures known in the prior art. The main advantages of the inventive system and method 100 of the present invention include the features of (1) diagnosing at a very elementary level, the initial response 102 of each question in each probe 106 provided by the student responder 104 during a test, (2) distinguishing between a literal correct response 116 and a literal incorrect response 118 to the test probes or questions 106, (3) identifying a literal correct response 116 to a test probe or question 106 with a confirmation of correction in the written reports 148, (4) identifying a literal incorrect response 118 for each question in a test probe 106 with a summarized deficiency report reciting the specific deficiencies and errors of the student responder 104 in past cumulative knowledge and production rule knowledge (i.e., new subject matter knowledge), (5) identifying the subject matter in which the student responder 104 lacks knowledge for re-teaching or tutoring purposes, and (6) assessing the level of the knowledge of the student responder 104 based upon her literal test responses 102 to the test probes or questions 106. The system 100 of the present invention provides the teacher with definite information regarding the specific deficiencies responsible for the inability of the student responder 104 to understand or learn the subject matter and to assess her knowledge base. The system 100 of the present invention is directed to determining what the student responder 104 does not know or understand regarding the subject matter and the assessing and acquisition of new knowledge, not what subject matter she has already mastered.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility.

It is therefore intended by the appended claims to cover any and all such modifications, applications and embodiments within the scope of the present invention. Accordingly,

What is claimed is:

1. A system for diagnosing deficiencies and assessing knowledge in test responses comprising:
a computerized testing station for presenting a probe comprising multiple questions to a responder;
an initial response analyzer communicating with said testing station for determining the correctness of each of a plurality of literal responses by said responder to each question of said probe;
a necessary knowledge determiner disposed to analyze each literal incorrect response to each question of said probe from said initial response analyzer with a first comparator matching memory having a stored list of possible incorrect responses for detecting each of responder's specific deficiencies in past cumulative knowledge;
a cumulative knowledge analyzer for analyzing each of said literal incorrect responses to each question of said probe with a second comparator matching memory having a stored list of possible incorrect responses for identifying each of said specific deficiencies in past cumulative knowledge, each literal incorrect response to each question of said probe resulting from one of said specific deficiencies; and
a report generator communicating with said cumulative knowledge analyzer for generating a written deficiency report for identifying each of said specific deficiencies resulting in said literal incorrect responses to said multiple questions of said probe.

2. The system of claim 1 further including an information storage facility for storing and providing access to responder's test results.

3. The system of claim 1 wherein said report generator includes a computer printer.

4. The system of claim 1 wherein said initial response analyzer further comprises a data storage memory.

5. The system of claim 1 further including an answer area for cooperating with said testing station for facilitating the solution to said multiple questions of said probe by said responder.

6. The system of claim 5 wherein said answer area provides a correct answer to each of said questions of said probe at said testing station in response to said responder's literal incorrect response.

7. A system for diagnosing deficiencies and assessing knowledge in test responses comprising:
a computerized testing station for presenting a probe comprising multiple questions to a responder;
an initial response analyzer communicating with said testing station for determining the correctness of each of a plurality of literal responses by said responder to each question of said probe;
a necessary knowledge determiner disposed to analyze each literal incorrect response to each question of said probe from said initial response analyzer with a first comparator matching memory having a stored list of possible incorrect responses for detecting each of responder's specific deficiencies in new subject matter knowledge;
a production rule analyzer for analyzing each of said literal incorrect responses to each question of said probe with a second comparator matching memory having a stored list of possible incorrect responses for identifying each of said specific deficiencies in new subject matter knowledge, each literal incorrect response to each question of said probe resulting from one of said specific deficiencies; and
a report generator communicating with said production rule analyzer for generating a written deficiency report for identifying each of said specific deficiencies resulting in said literal incorrect responses to said multiple questions of said probe.

8. A system for diagnosing deficiencies and assessing knowledge in test responses comprising:
a computerized testing station for presenting a probe comprising multiple questions to a responder;
an initial response analyzer communicating with said testing station for determining the correctness of each of a plurality of literal responses by said responder to each question of said probe;
a necessary knowledge determiner disposed to analyze each literal incorrect response to each question of said probe from said initial response analyzer with a first comparator matching memory having a stored list of possible incorrect responses for detecting each of responder's specific deficiencies in past cumulative knowledge and in new subject matter knowledge;
a cumulative knowledge analyzer for analyzing each of said literal incorrect responses to each question of said probe with a second comparator matching memory having a stored list of possible incorrect responses for identifying each of said specific deficiencies in past cumulative knowledge, each literal incorrect response to each question of said probe resulting from one of said specific deficiencies;
a production rule analyzer for analyzing each of said literal incorrect responses to each question of said probe with a third comparator matching memory having a stored list of possible incorrect responses for identifying each of said specific deficiencies in new subject matter knowledge, each literal incorrect response to each question of said probe resulting from one of said specific deficiencies; and
a report generator communicating with said cumulative knowledge analyzer and said production rule analyzer for generating a written deficiency report for identifying each of said specific deficiencies resulting in said literal incorrect responses to said multiple questions of said probe.

9. The system of claim 8 further comprising a subject matter processor communicating with said cumulative knowledge analyzer and said production rule analyzer for summarizing said deficiencies in past cumulative knowledge and in new subject matter knowledge.

10. A method for diagnosing deficiencies and assessing knowledge in test responses utilizing a computerized testing station, said method comprising the steps of:
presenting a probe comprising multiple questions on a computerized testing station for eliciting a plurality of literal responses from a responder;
analyzing each of said literal responses to each question of said probe from said responder for determining the correctness of each of said literal responses;
analyzing each of a plurality of literal incorrect responses to each question of said probe from said responder by comparing each literal incorrect response to a stored list of possible incorrect responses for detecting and identifying each of a plurality of specific deficiencies in past cumulative knowledge, each literal incorrect response to each question of said probe resulting from one of said specific deficiencies; and
generating a cumulative knowledge written deficiency report for identifying each of said specific deficiencies in said past cumulative knowledge.

11. The method of claim 10 further including the step of storing responder's test results in an information storage facility.

12. The method of claim 10 further including the step of retrieving responder's test results from an information storage facility.

13. The method of claim 10 wherein said step of generating a written deficiency report further includes the step of printing said written deficiency report.

14. The method of claim 10 further including the step of providing a correct answer to each question of said probe at said testing station in response to responder's literal incorrect responses.

15. A method for diagnosing deficiencies and assessing knowledge in test responses utilizing a computerized testing station, said method comprising the steps of:
presenting a probe comprising multiple questions on a computerized testing station for eliciting a plurality of literal responses from a responder;
analyzing each of said literal responses to each question of said probe from said responder for determining the correctness of each of said literal responses;
analyzing each of a plurality of literal incorrect responses to each question of said probe from said responder by comparing each literal incorrect response to a stored list of possible incorrect responses for detecting and identifying each of a plurality of specific deficiencies in new subject matter knowledge, each literal incorrect response to each question of said probe resulting from one of said specific deficiencies; and
generating a new subject matter written deficiency report for identifying each of said specific deficiencies in said new subject matter knowledge.

16. A method for diagnosing deficiencies and assessing knowledge in test responses utilizing a computerized testing station, said method comprising the steps of:
presenting a probe comprising multiple questions on a computerized testing station for eliciting a plurality of literal responses from a responder;
analyzing each of said literal responses to each question of said probe from said responder for determining the correctness of each of said literal responses;
analyzing each of a plurality of literal incorrect responses to each question of said probe from said responder by comparing each literal incorrect response to a stored list of possible incorrect responses for detecting and identifying each of a plurality of specific deficiencies in past cumulative knowledge and in new subject matter knowledge, each literal incorrect response to each question of said probe resulting from one of said specific deficiencies; and
generating a combined written deficiency report for identifying each of said specific deficiencies in said past cumulative knowledge and in said new subject matter knowledge.

17. The method of claim 16 further including the step of summarizing said specific deficiencies in said past cumulative knowledge and in said new subject matter knowledge prior to generating said combined written deficiency report.
